(19) United States
(12) Patent Application Publication
(10) Pub. No.: US 2026/0056124 A1
(43) Pub. Date: Feb. 26, 2026

(54) MICROELECTRONIC CHEMICAL CONCENTRATION SENSOR FUNCTIONALIZATION PLATFORM

(71) Applicant: Fluid Photonics Corporation, Plainview, NY (US)

(72) Inventor: Dean G Gouramanis, Lindenhurst, NY (US)

(73) Assignee: Fluid Photonics Corporation, Plainview, NY (US)

(21) Appl. No.: 19/209,334

(22) Filed: May 15, 2025

Related U.S. Application Data
(60) Provisional application No. 63/647,618, filed on May 15, 2024.

(51) Int. Cl. G01N 21/64

(52) U.S. Cl. CPC G01N 21/6428; G01N 21/645; G01N 2021/6471; G01N 2201/0826

(57) ABSTRACT

A sensor platform assembly includes a universal chassis and a waveguide housing disposed within the universal chassis that includes waveguides extending toward a sample region. The assembly also includes photodetectors that are configured for positioning within corresponding waveguides and optical filters that are configured for positioning between a corresponding photodetector and the sample region when the corresponding photodetector is positioned in a corresponding waveguide. The assembly includes at least one light source. The assembly is configured to be assembled into a sensor platform that includes a subset of the optical filters. The subset of optical filters are selected for inclusion in the assembled sensor platform based on optical properties corresponding to a target chemical sensor reagent and analyte combination. The optical properties correspond to a set of measurement wavelengths. Predetermined wavelengths of the selected subset of optical filters correspond to the set of measurement wavelengths.

### CROSS REFERENCE TO RELATED APPLICATION

This application claims the benefit of U.S. Provisional Patent application No. 63/647,618, filed on May 15, 2024, and entitled “MICROELECTRONIC CHEMICAL CONCENTRATION SENSOR FUNCTIONALIZATION TOOL” the content of which is incorporated by reference herein in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This application relates to chemical concentration sensors for performing concentration measurements of ion concentrations in a material sample, and in particular, to configurable chemical concentration sensor platforms for performing concentration measurements.

Detection of ion concentrations in a material sample is often challenging, especially for metal ions. Chemical analytical techniques often require lab space, substantial preparation, and manual labor which may be prone to error. Equipment and instrumentation for performing an analysis of ion concentrations may be bulky, expensive and time consuming. Often a chemist is required to move a sample material from a collection site, wait for equipment availability or simply cannot obtain equipment specifically configured for their use case.

### SUMMARY

In an embodiment, a configurable sensor platform assembly is disclosed. The configurable sensor platform assembly comprises a universal chassis and a waveguide housing disposed within the universal chassis. The waveguide housing comprises a plurality of waveguides extending therethrough toward a sample region. The configurable sensor platform assembly further comprises a plurality of photodetectors. Each photodetector is configured for positioning within a corresponding waveguide of the waveguide housing. The configurable sensor platform assembly further comprises a plurality of optical filters. Each optical filter is configured for positioning between a corresponding photodetector of the plurality of photodetectors and the sample region when the corresponding photodetector is positioned in a corresponding waveguide of the waveguide housing, each optical filter corresponding to a predetermined wavelength. The configurable sensor platform assembly further comprises at least one light source. The configurable sensor platform assembly is configured to be assembled into a sensor platform. The assembled sensor platform includes a subset of the plurality of optical filters that are selected for inclusion in the assembled sensor platform based on optical properties corresponding to a target chemical sensor reagent and analyte combination. The optical properties correspond to a set of measurement wavelengths. The predetermined wavelengths of the selected subset of optical filters correspond to the set of measurement wavelengths.

In an embodiment, a configurable sensor platform assembly is disclosed. The configurable sensor platform assembly comprises a chassis comprising a sample region, a waveguide housing configured for positioning within the chassis and comprising a plurality of waveguides and a circuit board stack configured for positioning within the chassis adjacent the waveguide housing. The circuit board stack comprises a circuit board comprising a light source, a circuit board comprising a flexible flange and a photodetector disposed on the flexible flange. The flexible flange is configured to adjust an angle of a receiving surface of the photodetector relative to the sample region.

In an embodiment, a sensor platform is disclosed. The sensor platform comprises a chassis comprising a sample region, a waveguide housing configured for positioning within the chassis and comprising a plurality of waveguide channels and a light source channel and a photodetector module comprising a plurality of photodetectors. Each photodetector is configured for insertion at least partially into a corresponding waveguide channel of the plurality of waveguide channels. The sensor platform further comprises a light source module comprising a light source. The light source is configured to emit light toward the sample region through the light source channel of the waveguide housing.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a cross-sectional diagram of an example sensor system and sensor platform according to an embodiment.

FIG. 2 is an exploded view of the sensor platform of FIG. 1 according to an embodiment.

FIG. 3 is an exploded view of the sensor platform of FIG. 1 according to an embodiment.

FIG. 4 is a side view of a waveguide housing of the sensor platform of FIG. 1 according to an embodiment.

FIG. 5 is a side view of the waveguide housing of FIG. 4 according to an embodiment.

FIG. 6A is an electrical diagram of an example photodetector unit of the sensor platform of FIG. 1 according to an embodiment.

FIG. 6B is an electrical diagram of an example photodetector unit of the sensor platform of FIG. 1 according to an embodiment.

FIG. 7 is a block diagram of a light source module of the sensor platform of FIG. 1 according to an embodiment.

FIG. 8 is a perspective view of a printed-circuit-board (PCB) carrier of the sensor platform of FIG. 1 according to an embodiment.

FIG. 9 is a cross-sectional diagram of an example sensor platform including a sample cartridge and orthogonal light source and photodetectors according to an embodiment.

FIG. 10 is a cross-sectional diagram of an example sensor platform including a sample cartridge according to an embodiment.

FIG. 11 is an exploded view of the sensor platform of FIG. 10 according to an embodiment.

FIG. 12 is a cross-sectional view of the sensor platform of FIG. 1 illustrating light traveling through an optical pathway toward a material sample according to an embodiment.

FIG. 13 is a cross-sectional view of the sensor platform of FIG. 1 illustrating light traveling from the material sample toward photodetectors of the sensor platform according to an embodiment.

FIG. 14 is a signal diagram illustrating an example light pattern from a light source having interference according to an embodiment.

FIG. 15 is a signal diagram illustrating an example light pattern of light from the light source of the sensor platform of FIG. 1 having improved distribution according to an embodiment.

FIG. 16 is an exploded view of a sensor platform including a light source module having a radiant-intensity sensor according to an embodiment.

FIG. 17 is a signal diagram illustrating an example excitation curve and process of controlling the radiant power of the light source of the sensor platform of FIG. 1 according to an embodiment.

FIG. 18 is a series of signal diagrams illustrating example analyte optical signals and corresponding filter transmission wavelengths of various optical filter elements that may be utilized in the sensor platform of FIG. 1 according to an embodiment.

FIG. 19 is a perspective view of a sensor system including an array of the sensor platforms of FIG. 1 according to an embodiment.

FIG. 20 is a perspective view of the sensor system of FIG. 19, illustrating the use of optional light guides according to an embodiment.

FIG. 21 is a perspective view of a diffusion membrane system installed on the sensor platform of FIG. 1 according to an embodiment.

FIG. 22 is a cross-sectional view of the diffusion membrane system of FIG. 21 according to an embodiment.

FIG. 23 is a cross-sectional view of the diffusion membrane system of FIG. 21 installed on the sensor platform of FIG. 1 according to an embodiment.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

An optoelectronic sensor system is disclosed that is configured for the functional deployment of photo-active chemical sensor reagents. The sensor system comprises an integrated chemical concentration sensor platform that is configured to determine a concentration of a target analyte in a sample. The sensor platform is configured to receive a sample comprising a chemical sensor reagent that is pre-characterized to exhibit a known optical effect when exposed to a target analyte. The sensor platform is configured to quantify an optical response caused by an interaction of the chemical sensor reagent with the target analyte in order to determine a concentration of the analyte in the sample.

The sensor platform may be user-programmable via a software application. For example, the software application may be configured to cause a presentation of adjustable configuration parameters or other criteria to a user, e.g., via a graphical user interface. In another example, the user may provide a data file comprising configuration parameters to the software application, e.g., in a CSV file or other format, which is used to program the sensor platform. For example, the user may provide a data file comprising reagent characterization data corresponding to one or more chemical sensor reagents to be used and one or more target analytes to be detected. The chemical sensor reagent characterization data may be utilized by the software application to configure the sensor platform for use with the chemical sensor reagent(s) to detect concentrations of the target analyte(s).

The sensor platform may be configured to determine a chemical concentration of the target analyte by quantifying a fluorescent response of the interaction between the chemical sensor reagent and the target analyte. For example, in some embodiments, the sensor platform comprises a fluorometer, e.g., a microelectronic fluorometer in some embodiments.

The sensor platform may also or alternatively be configured to determine a chemical concentration of the target analyte in a sample by quantifying an absorption of radiant power at one or more specific wavelengths.

A chemical concentration measurement system is disclosed that comprises a sensor platform. The sensor platform comprises a light source and a detector system. The light source is configured to excite a material sample, and the detector system is configured to quantify a radiant intensity of light that passes through or is transduced by the material sample while being excited by the light source. The chemical concentration measurement system also comprises hardware and/or software functionality that is configured to compute a chemical concentration of a target analyte from optical measurements by measuring the radiant energy received by one or more photodetectors of the detector system at a certain wavelength or wavelength range corresponding to each photodetector. For example, the radiant energy may be emitted, reflected or absorbed by the material sample. The magnitude of received radiant intensity may be proportional to the concentration of analyte in the material sample or may be utilized to determine the concentration of the analyte by a math function that is user programmable.

A measurement cycle is defined as a period of time when the sensor platform is modulating the radiant intensity of the light source while performing analog-to-digital conversion of the electrical power being transduced by the photodetectors, thereby producing an electronic data output that is generated based on the quantity of light energy being received by the photodetectors at their corresponding wavelength or wavelength range.

A system for rapidly creating and configuring deployable chemical concentration sensor platforms for use with photosensitive chemical sensor reagents that exhibit known optical responses in the presence of target analytes is disclosed. The sensor platforms comprise mechanical assemblies having components or other features which, when assembled, form a hermetically sealed chassis or a hardened exterior that is able to withstand extended service periods. For example, interchangeable components of the configurable sensor platforms may be shaped to result in a solid chassis structure containing a minimal amount of air voids when assembled, thereby reducing the effect of barometric pressure on differential pressure. The assembled configuration may contain thermal interconnects which act to transfer heat generated by circuitry to an exterior-facing surface of the sensor platform. The sensor platform may be configured for immersion into a fluid for cooling, for installation outdoors in humid and windy conditions, or for installation in any other environment or location. In example embodiment, structural components of a filter carrier or printed-circuit-board (PCB) carrier of the sensor platform may be constructed of a thermally-conductive material such as aluminum, copper or another thermally-conductive material and act to structurally retain the components within the sensor platform while providing a thermal pathway between the components and externally-facing surfaces of the chassis.

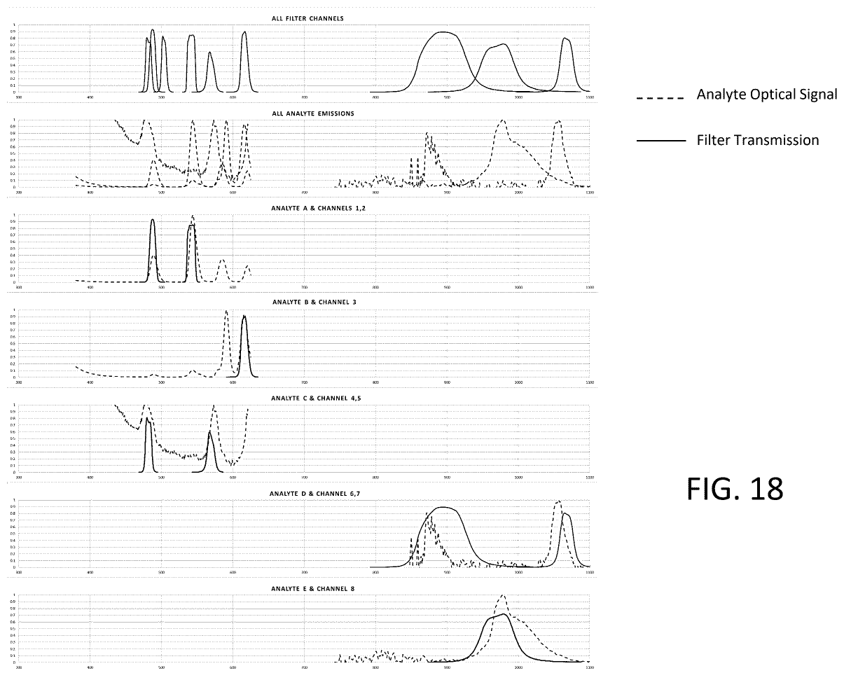

The system is configured to enable ease of deployment for analytical techniques that are developed experimentally, for example in a laboratory or other research environment. For example, the system may be configured to support the rapid functionalization of a sensor technology, e.g., a reagent-based chemical sensor technology, that is developed in a lab or in another research setting from a Technology Readiness Level (TRL) of 1 to a deployable state with a TRL of 6, 7, 8 or higher. For example, the system may configure a sensor platform based on the characteristics and attributes of particular chemical sensor reagent, such as a liquid chemical sensor reagent, a powdered chemical sensor reagent, a solid porous material or a composite material such gel foam that is impregnated with a chemical sensor reagent, and target analyte. The system is configured to select one or more optical filter elements to include in the sensor platform configuration which serve to specialize the frequency response of the optical instruments for selective quantification of the optical signature that is produced by a chemical sensor reagent and analyte combination, for example, as shown in FIG. 18. For example, the chemical sensor reagent, analyte, or both may produce an optical signature when excited by the light source.

The system is designed to accommodate a variety of chemical sensor reagents, allowing the system to be adaptable for targeting a wide variety of analytes. While chemical sensor reagents and analytes may vary, a majority of the components of the microelectronic platform embodied by the sensor platform may remain substantially the same with the system selecting, modifying or adjusting particular configurable features based on the target application. In this manner, the system and sensor platform provide a unified microelectronic platform that may be deployed for a multitude of purposes.

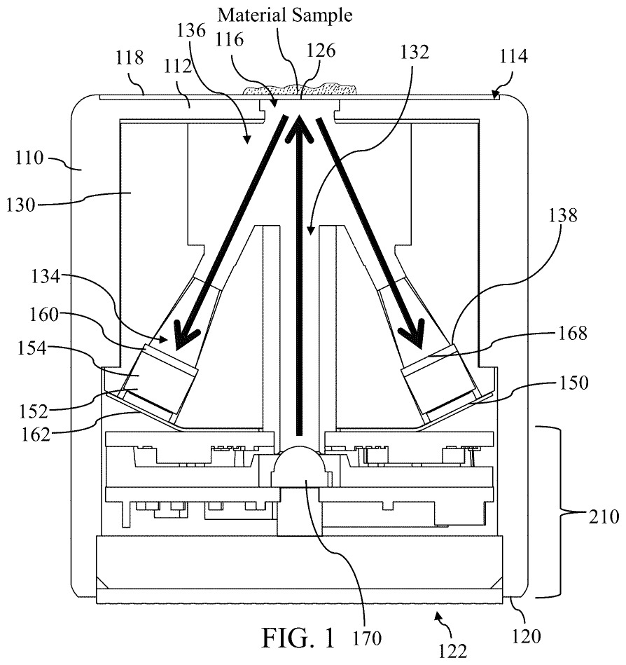

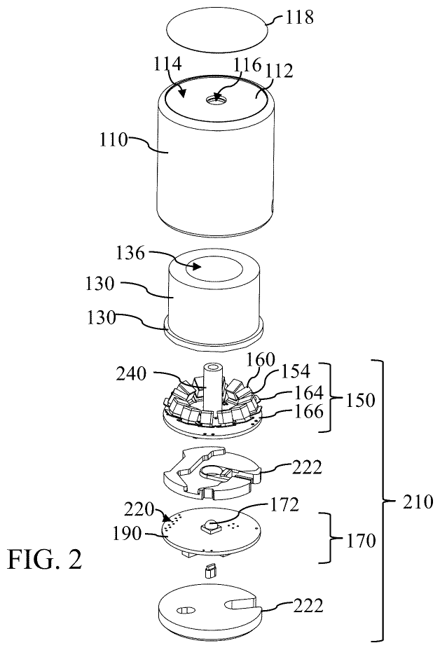

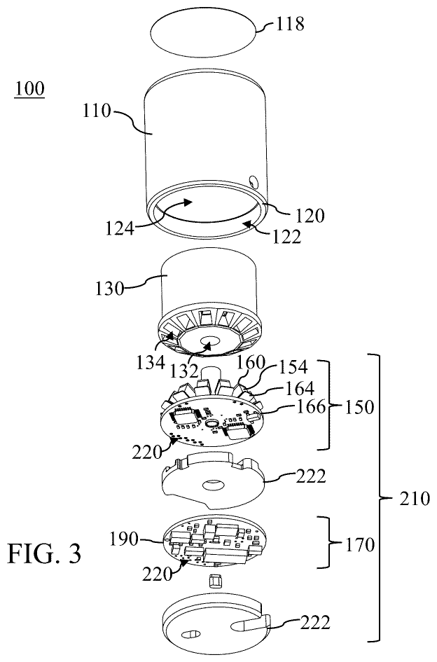

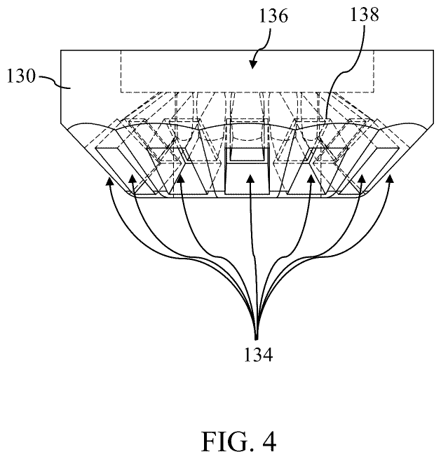

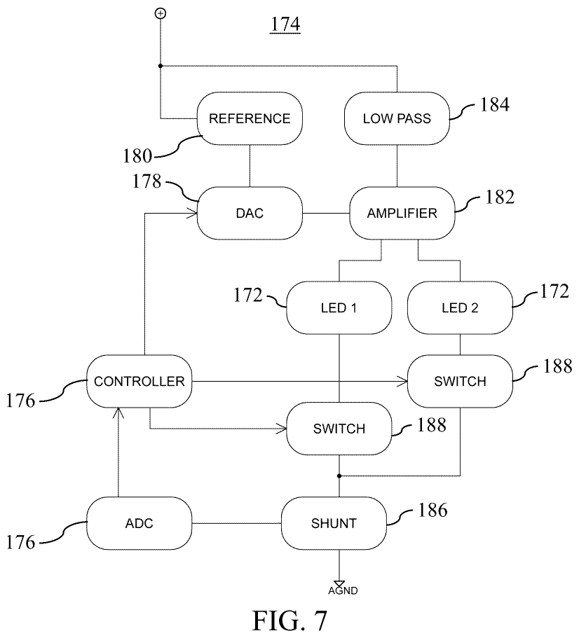

With reference to FIGS. 1-8, an example optoelectronic sensor system 10 is disclosed. Sensor system 10 comprises a configurable sensor platform 100 that comprises a chassis 110, a waveguide housing 130, a photodetector module 150, a light source module 170 and a printed-circuit-board (PCB) carrier 210.

Chassis 110 comprises a sample end 112 having a recess 114 and a through-hole 116 extending through a portion of recess 114. An imaging stage 118 is positioned within and attached to recess 114, e.g., via an adhesive or in another manner, and is configured to seal through-hole 116 relative to a sample material deposited on imaging stage 118. In some embodiments, imaging stage 118 may be planar. Imaging stage 118 may comprise, for example, glass, quartz or another material through which optical transmission is possible in the wavelengths being utilized for the analysis of a particular analyte, for a particular light source and for a particular chemical sensor reagent.

While imaging stage 118 is shown as being substantially larger than through-hole 116 in FIG. 1, in other embodiments, imaging stage 118 may be about the same size as through-hole 116, slightly larger than through-hole 116 or any other size relative to through-hole 116 such that optical communication with a material sample deposited on imaging stage 118 via through-hole 116 may be achieved.

Chassis 100 further comprises an instrumentation end 120 having an opening 122 therein to a cavity 124. Cavity 124 extends from opening 122 of instrumentation end 120 to through-hole 116 of sample end 102 and is in optical communication with imaging stage 118 via through-hole 116.

With reference to FIGS. 1-5, waveguide housing 130 is configured for insertion into cavity 124 of chassis 100 via opening 122 and may be secured within chassis 100. For example, waveguide housing 130 may be secured within cavity 124 using screws, snap-fit, adhesives, or in any other manner. In some embodiments, an epoxy or another material may be utilized to secure waveguide housing 130 within cavity 124 or to provide additional securement or insulation, e.g., to inhibit the intrusion of fluids into cavity 124.

Waveguide housing 130 comprises a light source channel 132 and a plurality of waveguide channels 134 that extend into a central chamber 136. Central chamber 134 is exposed to cavity 124 and is positioned adjacent through-hole 116 when waveguide housing 130 is installed within chassis 100.

Light source channel 132 and waveguide channels 134 may contain waveguides made of absorbent materials such as, e.g., graphite, black plastic or other absorbent materials. In some embodiments, the absorbent material may correspond to the particular wavelengths that will be received by components of photodetector module 150, emitted by light source module 190, or any other wavelengths. The waveguides are configured to control the directionality of incident light entering one or more photodetector units 152 of photodetector module 150, or the directionality of incident light entering the target region of imaging plate 118 where the material sample is deposited. The waveguides may be configured to trap or dissipate energy from scattered light in order to negate the effect of interference patterns. In this manner, sensor platform 100 may inhibit or reduce the occurrence of measurement error due to mechanical shifting of the material sample. In addition, by utilizing absorbent waveguides, sensor platform 100 may be more tolerant of variations in the position of the material sample or test strips containing the material sample relative to the photodetectors of photodetector module 150 and light source module 170.

With reference to FIGS. 1-3, 6 and 8, photodetector module 150 comprises one or more photodetector units 152. Each photodetector unit 152 is separately configurable by sensor system 10 on assembly or during refit and comprises one or more of a photodetector 154, a resistor 156, an ADC 158 and an optical filter element 160.

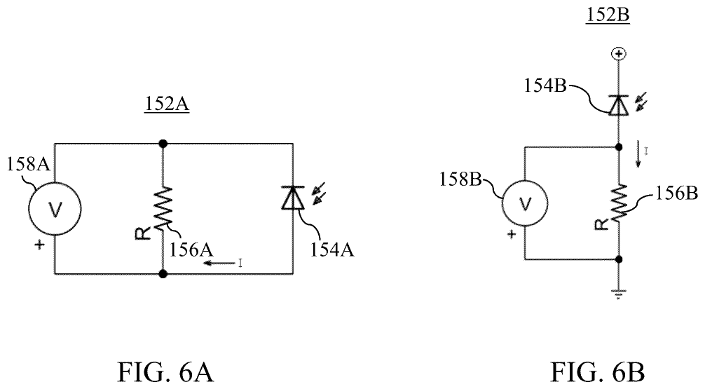

Photodetectors 154, as described herein, refer to a light-sensitive semiconductor or any other light sensitive transducer acting to translate radiant intensity to an electrical signal. Some examples photodetectors 154 include, e.g., a photodiode, a phototransistor, photoresistor, photomultiplier and a composite optoelectronic device. FIGS. 6A and 6B each illustrate an example embodiment of photodetector unit 152. For ease of reference, components of photodetector unit 152 in FIG. 6A include a reference character A and components of photodetector unit 152 in FIG. 6B include a reference character B. Each photodetector unit 152 comprises an electrical circuit that is formed such that an electrical potential that is transduced by photodetector 154 is communicated via wiring across resistor 156. ADC 158 is configured to measure a voltage rise across resistor 156. The voltage rise is proportional to amperage conducted through resistor 156. In some embodiments, a separate ADC 158 may be utilized for each photodetector unit 152. In some embodiments, one or more photodetector units 152 may utilize a single ADC 158 by, e.g., using a multiplexer or another signal switching mechanism.

Photodetector module 150 may be integrated into a flexible PCB (FPCB) 162 that is adjustable to change an orientation and position of some or all of the mounted components of each photodetector unit 152 during assembly without inhibiting the electrical connection. For example, FPCB 162 may comprise a plurality of flexible arms 164, each of which is configured to flex or bend on assembly. As an example, photodetector 154 and optical filter element 160 of photodetector module 152 may be disposed on a corresponding flexible arm 164.

Photodetector module 150 may also comprise a PCB 166 on which some of the components of each photodetector unit 152 may be located. FPCB 162 may be attached to PCB 166 with PCB 166 and FPCB 162 together comprising the components of photodetector module 150. As an example, in an embodiment, photodetectors 154 and optical filter elements 160 may be located on FPCB 162 while other electrical components of photodetector module 150 may be located on PCB 166. In some embodiments, FPCB 162, PCB 166.

Each photodetector unit 152 produces digital data representing the electrical power generated by the transduction of radiant energy striking its photodetector 154 where, for example, the electrical power may be equal to the amperage squared divided by the resistance in ohms.

FPCB 162 allows the system to configure the orientation of photodetector 154 and optical filter element 160 for each photodetector unit 152 such that they are aligned relative to a target sample region 126 of imaging stage 118, e.g., a receiving surface 168 of photodetector 154 may be aligned such that a normal extending from receiving surface 168 intersects target sample region 126 where the material sample is deposited or may be aligned to any other alignment as needed. Depending on the type of sampling that system 10 is configuring sensor platform 100 to perform, a different orientation of photodetector 154 and optical filter element 160 may be utilized, e.g., by adjusting the flexible arms 164 of FPCB 162 on which the relevant photodetector 154 and optical filter element 160 are attached as shown in FIGS. 1 (planar sample configuration) and 9 (orthogonal sample configuration) for example.

With reference to FIGS. 1-5, each waveguide channel 134 of waveguide housing 130 is configured to receive photodetector 154 and optical filter element 160 of a corresponding photodetector unit 152 such that light entering the corresponding photodetector 154 must pass through the active surface of the corresponding optical filter element 160. For example, each optical filter element 160 may comprise a glass substrate that is coated with several layers of reflective coating, absorbent coating, any other coating or any combination thereof, that provides a filtering effect on the wavelength of light that is allowed to pass through that optical filter element 160.

In some embodiments, each waveguide channel 134 of waveguide housing 130 may comprise a stop element 138, e.g., a lip, ridge or other similar feature, that is configured to engage against or be positioned adjacent to receiving surface 168 of the corresponding optical filter element 160 when the corresponding photodetector 154 and optical filter element 160 are positioned within that waveguide channel 134. For example, stop element 138 may define a narrowing of waveguide channel 134, where, for example, receiving surface 168 of the corresponding optical filter element 160 may have a larger surface area than the cross section of the narrowed portion of the corresponding waveguide channel 134 adjacent stop element 138. In some embodiments, the engagement or positioning of optical filter elements 160 relative to the corresponding stop elements 138 is configured to inhibit light from passing around receiving surfaces 168 of optical filter elements 160 such that only light passing through optical filter elements 160 is received by the corresponding photodetector 154.

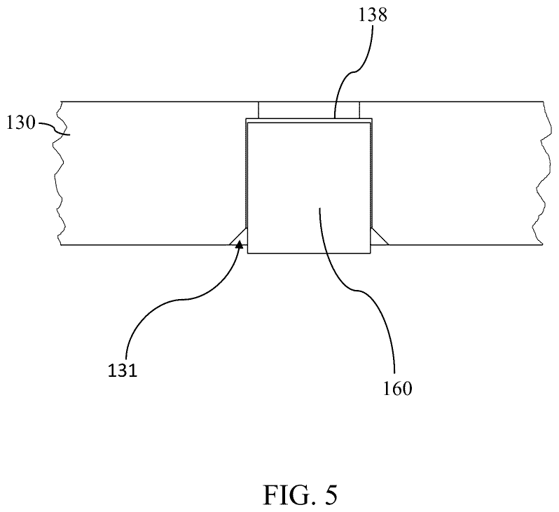

With reference to FIG. 5, in an embodiment, waveguide housing 130 may comprise a gland 131 that is configured to receive an opaque sealant, for example RTV silicone. The sealant may be configured to inhibit scattered light from passing around the active surfaces of optical filter elements 160.

With reference to FIGS. 1-3, 7 and 8, light source module 170 comprises a light source 172 on a such as, e.g., a light-emitting-diode (LED) or another type of light source, that may be selected or configured during configuration by system 10. A PCB 190 comprising electrical contacts and a thermal interconnect is configured to mate with light source 172. The mating features may be consistent with industry-standard LED packages, such that the sensor platform 100 provides ease of connection to a wide variety of LED light sources 172. The electrical contacts are interfaced with a software-modulated constant-current DAC 174. The circuitry of DAC 174 is configured to enable precise current modulation, independent of the LED characteristics, making it possible to install a wide variety of LEDs in sensor platform 100 and to control them via software without needing to modify the electrical circuitry. For example, infrared LEDs typically have forward-voltage (Vf) characteristics in the range of 1.2 volts to 1.5 volts and ultraviolet LEDs typically have a Vf in the range of 3.4 volts to 3.7 volts. The DAC 174 circuitry is configured to modulate current, independent of Vf so that either LED may be installed in the configurable sensor platform 100 and corresponding current may be commanded via internal or external software regardless of the type of light source 172 that is installed.

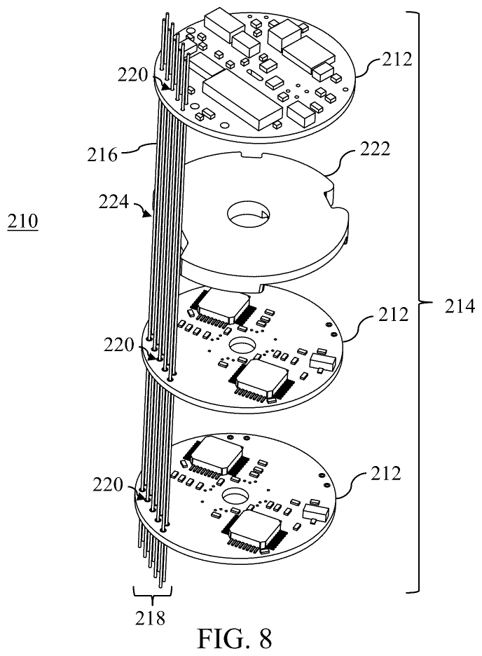

An example schematic of DAC functionality for DAC 174 that may be utilized for controlling light source 172 is illustrated in FIG. 8. DAC 174 comprises a constant-voltage power supply 176 such as, e.g., a liner regulator, an R-2R DAC 178 that is configured to act as a variable series resistor, a reference voltage supply 180, an amplifier 182, e.g., a transistor such as a bipolar junction transistor (BJT), field effect transistor (FET), Metal-Oxide-Semiconductor FET (MOSFET) or any other types of circuitry that may function as an amplifier, a low-pass filter 184, a shunt resistor 186 and one or more switches 188, e.g., transistors such as BJTs, FETs, MOSFETS or any other types of switching circuitry. R-2R DAC 178 is configured to receive electronic data representing a resistance value from a computation module, e.g., a processing device comprising one or more processors and memory, also referred to herein as a controller. Current supplied by reference voltage supply 180 is conducted through R-2R DAC 178 and enters the base of amplifier 182. Amplifier 182 functions to amplify the current supplied by R-2R DAC 178, for example, by a factor of 1000 or any other amplification factor, which may be configurable. The collector and emitter of the amplifier transistor of amplifier 182 are connected in series with light source 172, low-pass filter 184, shunt resistor 186, and constant-voltage power supply 176 and in series with one or more of switches 188, e.g., in a case where two light sources 172 may be available. The amperes passing through shunt resistor 186 is equal to the amperes passing through the active light source 172. In some embodiments, an ADC may be configured to measure the voltage across shunt resistor 186, thereby producing electronic data representing the LED current of the active light source 172 by dividing the measured voltage by the shunt resistance in ohms. In some embodiments, several light sources 172 may be connected in series with the amplified output of the DAC circuitry and may be independently activated by activating the switch 188 corresponding to each light source 172. In other embodiments, a single light source 172 may be utilized.

With reference to FIGS. 1-3 and 8, PCB carrier 210 comprises one or more PCBs 212, collectively or individually referred to herein as PCB(s) 212, which may be grouped together as a PCB stack 214. In some embodiments, multiple PCB stacks 214 may be utilized.

PCB stack 214 includes one or more through-board pins 216, also referred to herein as a pin array 218. Pin array 218 is configured to provide electrical communication between two or more PCBs 212 of PCB stack 214. For example, pins 216 of pin array 218 may be inserted through corresponding pin slots 220 of each PCB 212 and may be secured in place and electrically coupled to the PCBs by any conventional method such as, e.g., soldering or other methods of electrically connecting pins 216 to PCBs 212. In some embodiments, one or more slots of a particular PCB 212 may comprise dummy slots that provide no electrical connectivity to a corresponding pin 216 extending therethrough. In this manner electrical connections may be made to or between any PCBs 212 while allowing electrical separation from other PCBs 212 for those pins 216.

Pin array 218 may be configured to transmit electrical signals between PCBs 212 of PCB stack 214, e.g., as a data bus, as a power bus, as both a data bus and a power bus or in any other manner. For example, one or more pins 216 of pin array 218 may be utilized as a serial data bus, parallel data bus or as any other data bus in some embodiments. Pins 216 of pin array 218 may also provide an electrical pathway for data and power to travel from PCB stack 214 to other circuitry of sensor platform 100 or to external connections off of sensor platform 100.

During assembly or refit, sensor system 10 may be configured select different PCBs 212 to be added to or removed from PCB stack 214 of PCB carrier 210, with each PCB 212 being configured to make an electrical connection with pin array 218 when added to PCB stack 214. Electronic data may be made available bi-directionally between PCBs 212 that are added to PCB stack 214 and the data bus of pin array 218 without the need for electrical modification of PCBs 212. For example, one or more of PCBs 212 in PCB stack 214 may comprise plug and play PCBs that are selected for inclusion by sensor system 10 in sensor platform 100 based on the characteristics of the chemical sensor, analyte or other environmental parameters for which sensor platform 100 is being configured.

Example PCBs 212 that may be selected by sensor system 10 for inclusion in the sensor platform 100 include one or more PCBs 212 comprising one or more of power supply circuitry, serial data communication circuitry, wireless communication circuitry, computation circuitry such as, e.g., one or more processors and memory, a light source and corresponding circuitry, digital-to-analog converter (DAC) circuitry, analog-to-digital converter (ADC) circuitry, one or more photodetectors and corresponding circuitry, bandpass-photodetector circuitry, diffractive CCD spectrometer circuitry, a temperature sensor and corresponding circuitry, an ultrasonic transducer and corresponding circuitry, fluid pump control circuitry, memory (e.g., flash, volatile, non-volatile or any other type of memory), or a combination of any of the aforementioned components or circuitry combined on a single PCB 212 or any number of PCBs 212 in PCB stack 214. For example, in some embodiments, PCBs 212 may comprise one or more of FPCB 162, PCB 166 and PCB 190.

With reference to FIGS. 1-3 and 8, PCB stack 214 may also comprise one or more intermediary spacers 222 that may be positioned between adjacent PCBs 212 in PCB stack 214, as shown in FIG. 8. Spacers 222 may be individually and collectively referred to herein as spacer(s) 222. Each spacer 222 may comprise a slot 224 that is configured to receive pin array 218 therethrough. In some embodiments, pin array 218 is spaced apart from spacer 222 and does not contact spacer 222. In other embodiments, one or more spacers 222 may comprise one or more slots 220, which may comprise dummy slots in some embodiments. In other embodiments, a spacer 222 may comprise electrical circuitry that is configured to electrically transfer a signal from one of pins 216 to another of pins 216, or to another location.

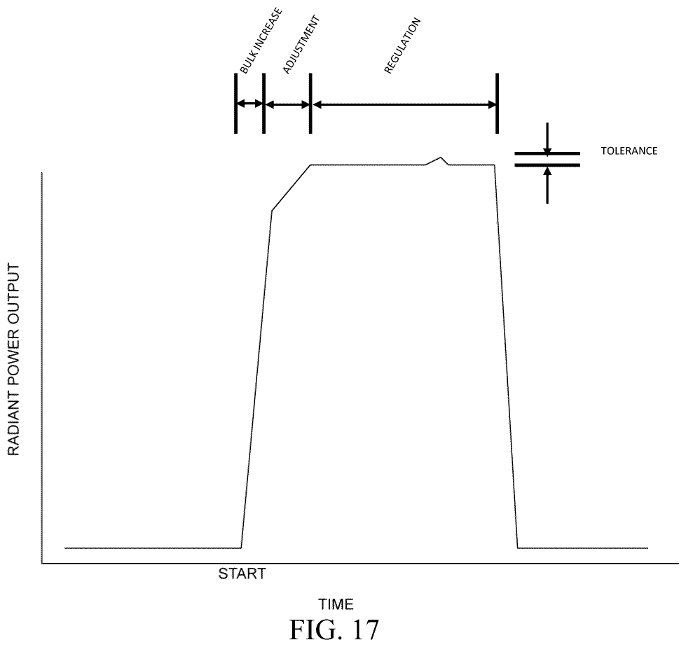

Light source 172 and photodetectors 154 are directionally oriented toward a central volume of space, referred to as target sample region 128 of imaging plate 118, such that the material sample may be simultaneously excited and measured. For example, a material sample located in the sample region may receive light emissions from light source 172 and light emissions from the material sample may be received by photodetectors 154. In an embodiment, light source 172 and one or more photodetectors 154 are located adjacent one another, e.g., with substantially parallel light paths, and orientated toward an imaging stage 118 such as shown in FIG. 1. It is understood that substantially parallel in this context may comprise parallel or may comprise an acute angle between the light source 172 and one or more of photodetectors 154 such as, e.g., 5°, 10°, 15°, 20° or any other angle in the range between 0° and 45°. In some embodiments, the angle between light source 172 and one or more photodetectors 154 may also or alternatively be between 45° and 90°. In yet other embodiments, one or more photodetectors 154 may be positioned perpendicular to light source 172, e.g., as shown in FIG. 17, or at an angle greater than 90°. In some embodiments, such as that shown in FIG. 17, photodetectors 154 may be positioned such that receiving surface 168 of photodetector unit 150 is substantially parallel to a transparent side wall of the waveguide housing 130 or target sample region 128. In some embodiments, for example, one or more photodetectors 154 may be disposed on an opposite side of target sample region 128 relative to light source 172, e.g., 180° or another angle disposed on the other side of target sample region 128 relative to light source 172.

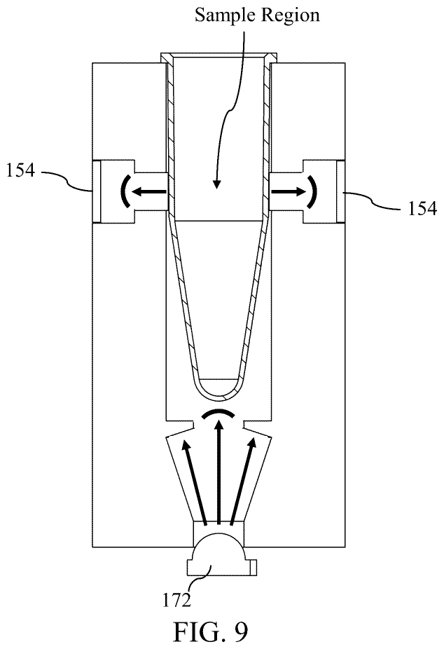

With reference to FIG. 9, in an embodiment, light source 172 may be oriented coaxially with a cylindrically-shaped sample region, and multiple photodetectors 154 may be arranged radially around the central volume, such that the light path from light source 172 to the sample region, and the light path from the sample region to photodetectors 154 are arranged orthogonally, at an acute angle, at an obtuse angle or at any other angle relative to one another. In some embodiments, the photodetectors may be arranged radially around the light source, radially around the sample region, or radially around any other point or line and oriented toward the sample region.

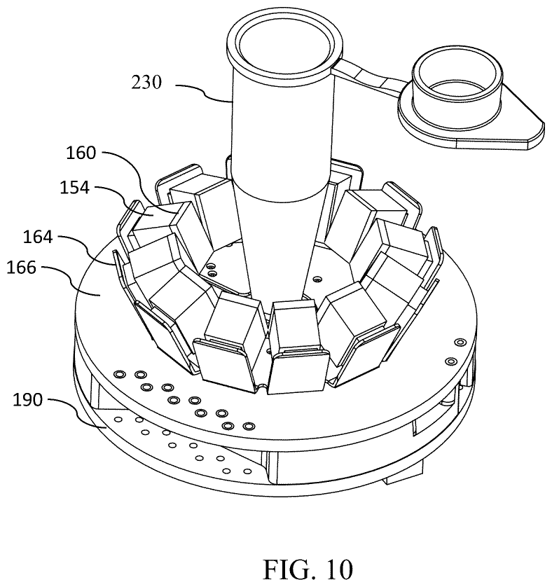

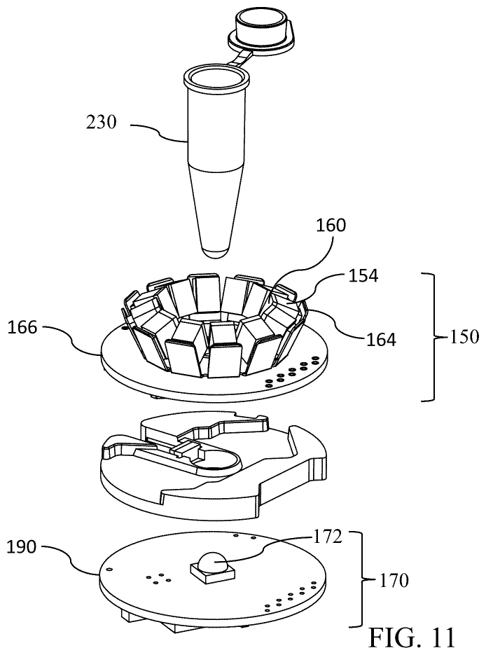

In some embodiments, the material sample may be disposed or positioned on imaging stage 118 such as shown in FIG. 1. In other embodiments, the material sample may be provided within a sample cartridge 230 such as that shown in FIGS. 9-11. Sample cartridge 130 may comprise a container such as a tube, cuvette or other sample cartridge or may comprise a test strip containing a microfluidic circuit or a hydrophilic well. A fluid material sample containing an analyte may flow into the sample cartridge by capillary action, through active pumping, via pipette, or in any other manner. For example, the material sample may comprise water containing a dissolved analyte, oil containing a dissolved analyte, acid mine drainage containing a dissolved analyte or any other solution containing a dissolved analyte. In some embodiments, the sample cartridge 230 may be filled or impregnated with the material sample containing the dissolved analyte prior to placement within sensor platform 100.

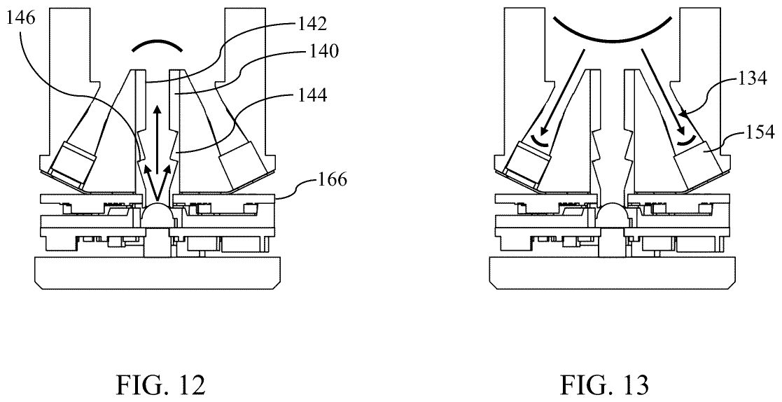

With reference to FIGS. 12 and 13, radiant energy, for example infrared light or visible light, being emitted from the material sample tends to form a spherical or gaussian distribution in free space. The quantity of light energy that is received by photodetector 154 is inversely related to the distance between the sample region and photodetector 154 due to the divergence or dissipation of the radiant energy originating from the sample region. Because of this property, the degree to which light source 172, sample region and photodetectors 154 can be integrated to occupy a minimal three-dimensional space is related to the maximum achievable signal-to-noise ratio or the strongest possible optical signal. For example, a smaller, more compact sensor platform 100 with the smallest possible distances between the sample region and each of light source 172 and photodetectors 154 may be a higher-performing sensor platform 100 as compared to a sensor platform 100 having a longer distance between these components.

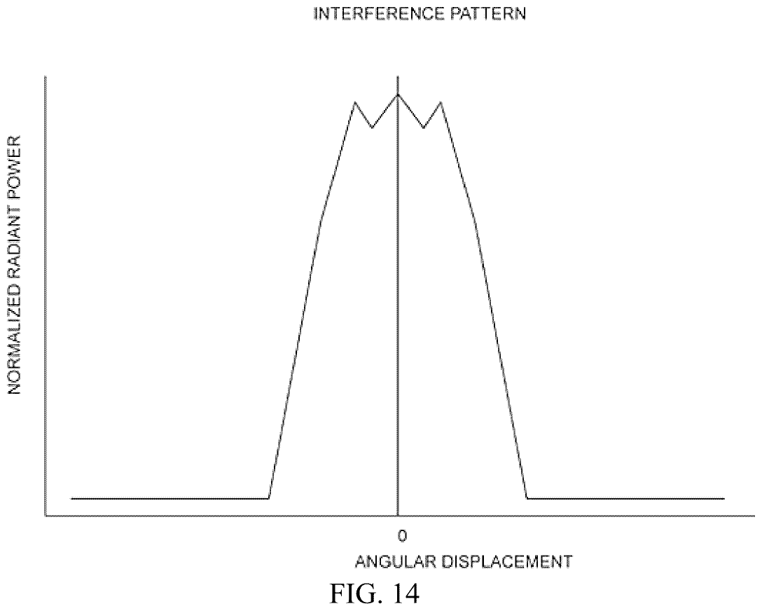

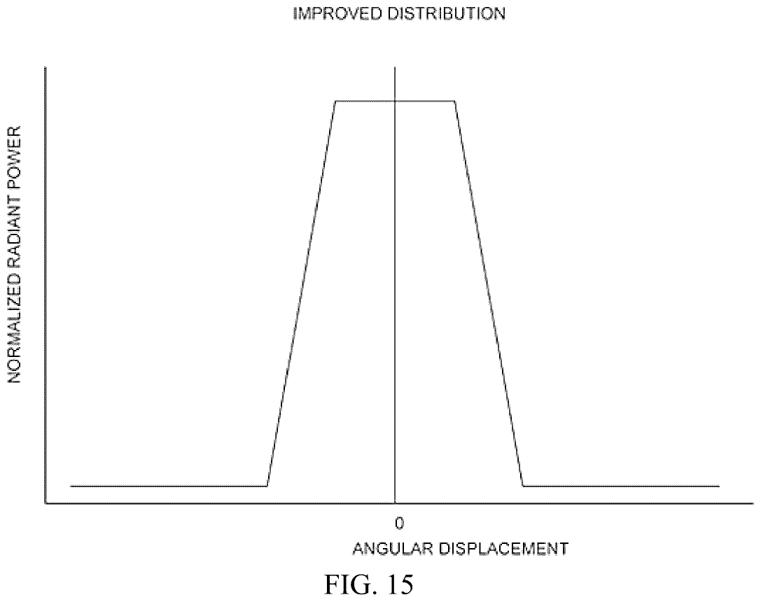

With reference to FIGS. 12-16, light source 172 is configured to deliver a known excitation to the sample region in the form of radiant energy. Sensor platform 100 comprises an optical pathway 140 that is configured to deliver a known density of radiant power to the sample region from light source 172. Features of optical pathway 140 are configured to minimize or inhibit scattering and interference patterns, such as those shown in the example of FIG. 14, resulting in an even distribution of radiant power entering the target sample region 126 from light source 172 such as that illustrated in the example of FIG. 15. LEDs typically do not produce a parallel beam of light. For this reason, optical pathway 140 may be constructed of a light-absorbent material such as carbon graphite, black plastic or another light-absorbent material that is configured to absorb the wavelength of light being emitted by light source 172, in order to maximize absorbance of radiant power striking inner walls 142 of optical pathway 140. In some embodiments, inner walls 142 of optical pathway 140 may be textured or may comprise ridged baffles 144 having normal surfaces 146 oriented toward light source 172 in order to minimizing or inhibit reflections off of inner walls 142 of optical pathway 140, for example, as shown in FIG. 12. The use of textured surfaces or ridged baffles 144 may result in a maximal conversion of stray light into heat by inner walls 142 of light pathway 140 as possible. The result is an optical pathway that is configured to allow transmission of significantly parallel rays of light from light source 172 to the sample region, with the exiting radiation being distributed evenly across the aperture and free of ripples from interference patterns, e.g., as shown in FIG. 12. In some embodiments, light source channel 132 may comprise optical pathway 140. In other embodiments, optical pathway may be attached to PCB 166 of photodetector module 150 and be configured for insertion into light source channel 132 when photodetector module 150 is installed on sensor platform 100.

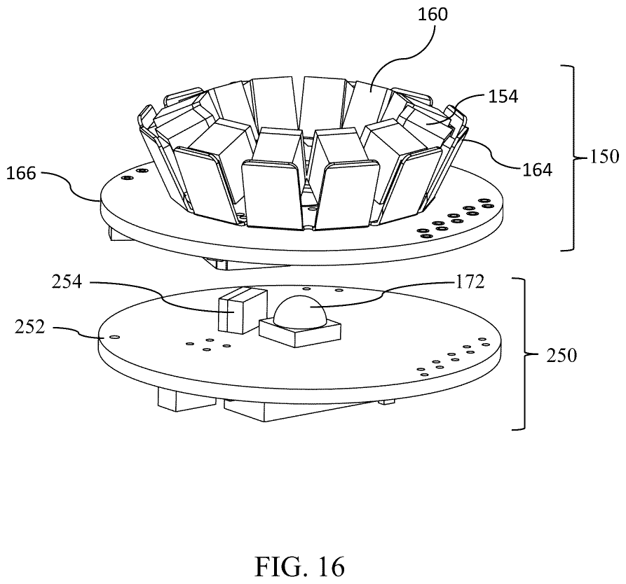

With reference to FIG. 16, in some embodiments, sensor platform 100 may comprise a light source module 250 including a PCB 252, e.g., usable as one of PCBs 212, that includes a radiant-intensity sensor 254 in addition to light source 172. Radiant-intensity sensor 254 may comprise a feedback photodetector or another component that is in optical communication with light source 172 and provides electrical signals to an ADC that are accessible by software. Utilizing feedback from radiant-intensity sensor 254, sensor platform 100 may be configured with a software-modulated precision radiometric light source 172 that may be programmed by an end user in units of radiant power, for example, milliwatts. Other units of control may alternatively be utilized including amperes, voltage, etc. In an embodiment, electrical power entering light source 172 may be commanded by an internal software module in units of milliamps, while brightness may be regulated by another software module that is monitoring the radiant power measurements provided by radiant-intensity sensor 254. The result is an integrated feature of sensor platform 100 which is configured to receive commands in units of milliwatts or another unit and is able to modulate and sustain the exact brightness of light source 172.

Radiant-intensity sensor 254 may be placed orthogonally, for example at ninety angular degrees from the axis of light source 172, e.g., as shown in FIG. 16. In some embodiments, radiant-intensity sensor 254 may be shielded from the sample region, e.g., by the construction of the optical pathway, by the body of the waveguide housing 130 or in another manner. In such a position, light reflected or emitted from the sample region, e.g., by an excited sample, is inhibited from interacting with radiant-intensity sensor 254. In some embodiments, an opaque barrier may be positioned between radiant-intensity sensor 254 and the sample region, for example a PCB, that provides nearly complete optical isolation from an excited sample contained in the sample region. In this manner, radiant-intensity sensor 254 measures radiant power that is proportional to the total radiant power being produced by light source 172, e.g., for use in a feedback circuit.

With reference to FIG. 17, an example activation curve of light source 172 for a measurement cycle is described. The duration of time required for sensor platform 100 to switch light source 172 between one commanded brightness level and another commanded brightness level is proportional to the excess energy that is delivered to the sample region and the sample material contained therein. For example, light source 172 may be switched completely off and then be commanded to produce a constant-brightness excitation of 20 milliwatts in the shortest latency possible. It may be desirable to deliver as little excess power as possible to the sample material in order to minimize degradation of the optical characteristics by heat or chemical depredation from ultraviolet light.

Sensor platform 100 is configured to perform rapid precision adjustments. For example, the time of transience may be 1 millisecond. Sensor platform 100 comprises electrical circuitry that is configured to rapidly adjust the electrical power and inhibit or prevent resonance issues, such as ringing or overshooting, which would result in a lengthening of the time required to reach the programmed radiant power level and inhibit inconsistent delays. In this manner, inconsistent energy delivery may be inhibited when reaching the programmed brightness.

Radiant-intensity sensor 254 of light source module 170 may be disposed in close proximity to light source 172 and DAC 174. Heat produced by the circuitry of DAC 174 and also radiant power produced by light source 172 may cause an increase in the temperature of radiant-intensity sensor 254 which may affect the characteristics of radiant-intensity sensor 254. For example, changes in temperature may increase or reduce the transduction efficiency of radiant-intensity sensor 254. In some embodiments, one or more temperature sensors may be disposed in close proximity to radiant-intensity sensor 254 (or other components such as light source 172 and photodetectors 154) or be integrated with PCB 190 of light source module 170 in order to precisely measure the temperature of radiant-intensity sensor 254. Software modules of sensor platform 100 may be configured to inhibit or negate the effect of temperature on the light measurements or chemical concentration measurements.

The embedded software, e.g., firmware, of sensor platform 100 is configured to control the measurement process and to translate concentration measurements from raw optical data. The measurement process may be triggered by an external stimulus such as the receipt of a command from a user device such as a tablet, smart device, computer, or any other user device. As an example, the user device may comprise a button or other element that may be pressed to issue a command to the sensor platform or may submit a command to sensor platform 100 in any other manner. The measurement process may also be continuously repeated, for example at a frequency of 40 samples-per-second or any other frequency. Data resulting from each measurement process may be communicated electronically to the end user device, to a host network, server, remote server, cloud server or any other storage location. In some embodiments, sensor platform 100 may also or alternatively store the date locally in electronic memory, on a removable memory card or in another similar manner for later retrieval.

A command message may comprise process parameters that are received by sensor platform 100. The process parameters may be stored in memory that is accessed by software. For example, a command message comprise bytes or words representing process parameters such as, e.g., the excitation power in milliwatts, the duration of time to delay after the programmed excitation power has been reached before measuring the optical response, the duration of exposure for an electronic shutter, the ADC clock frequency, the number of consecutive measurements to perform, the number of consecutive measurements to average and return as a single measurement, the period of time to delay between measurements, or any other parameter that may be utilized to control the measurement process. In some embodiments, the command message may also comprise a process parameter corresponding to the activation and deactivation of a command mode which enables a user to activate or deactivate particular software modules contained in sensor platform 100.

During an idle period, sensor platform 100 may be configured to enter a low-power mode. For example, the CPU clock speed may be decreased or disabled, a portion of the circuitry may be switched off, light source 172 may be configured for zero power output or take other similar actions to reduce the amount of power used by sensor platform 100.

With reference again to FIG. 17, in an example measurement process, measurement cycles may begin by scaling the radiant power output of light source. The process may comprise a bulk increase stage, an adjustment stage and a regulation stage. During the bulk increase stage, the radiant power is scaled up rapidly to a predetermined percentage of the target value, e.g., 80%, 85%, 90%, 95% or any other amount of radiant power.

The adjustment stage may comprise a single stage or alternatively a coarse adjustment stage and a fine adjustment stage. In the coarse adjustment stage, the radiant power may continue to be scaled up, but at a slower rate than the bulk increase stage. In the fine adjustment stage, the rate of scaling of the radiant power is further decreased to enable fine control of the radiant power output in order to achieve the target radiant power while inhibiting any significant overshoot over the target radiant power.

Following the adjustment stage, response measurements are performed during the regulation stage. Once the regulation stage has been entered, sensor platform 100 may be configured to delay a predetermined period of time before sampling the optical response data, for example, in a case where there is a delay between excitation of the sample material by the light source and emission by the sample material, e.g., due to the delay in chemical processes. In a case where no such delay is present, sensor platform 100 may be configured to begin sampling immediately or within a short period of time after entering the regulation stage.

The measurement software may comprise variables that are adjusted by the system 10 during the configuration and manufacturing process of sensor platform 100. For example, the variables may be adjusted for the characteristics of each individual sensor platform 100 in order to compensate each sensor platform 100 for slight variations in the electrical or optical characteristics of components of that sensor platform 100. In this manner, sensor platforms 100 may be produced in large quantities with a known precision, for example, less than 1% error in some embodiments.

In some embodiments, sensor platforms 100 may be factory-calibrated by interfacing the sensor platforms 100 with a test apparatus. The test apparatus may generate calibration values for each sensor platform 100, or the calibration values may be automatically transferred to each sensor platform 100 by the test apparatus. For example, sensor platform 100 may be commanded to produce an excitation of exactly 20 milliwatts. The excitation may be measured by the test apparatus in order to determine a calibration value based on the measured deviation from the commanded value. As part of the test, the data from radiant-intensity sensor 254 may be compared to the data generated by the test apparatus and the calibration values for radiant-intensity sensor 254 may also be adjusted to ensure as precise a measurement as possible.

During the bulk increase stage, sensor platform 100 is configured to compute an output value for DAC 174 that is less than the value that will be required in order to reach the programmed radiant power value. For example, the bulk increase stage may result in an instantaneous radiant power output equal to 75% of the commanded value. Sensor platform 100 computes the bulk increase value by multiplying the commanded value by a calibration value. The purpose of the bulk increase stage is to greatly reduce the amount of time required to reach the programmed radiant power. Upon the transition of the value output by DAC 174 from zero to the bulk value, amperage increases rapidly, and the slew rate is limited electrically by low-pass filter 184.

During the coarse adjustment stage, amperage or radiant power may be polled by sensor platform 100 in order to regulate power scaling. Sensor platform 100 may calculate a target threshold by multiplying the commanded radiant power by a tolerance coefficient. For example, sensor platform 100 may operate in coarse-adjustment mode until the radiant power level reaches 90% of the commanded value. If the instantaneous output is less than the target threshold value, the output of DAC 174 is increased by a coarse increment value, e.g., 1% or another increment value. In some embodiments, the increment value may be adjusted based on the measured deviation from the target threshold value, e.g., the coarse increment value may be increased when the output of DAC 174 is farther from the target threshold value and decreased as the output of DAC 174 approaches the target value. When the target threshold value is exceeded, coarse-adjustment mode is exited.

Tolerance coefficients may be positive and negative. For example, the instantaneous output may be measured at below 90% of the commanded value prior to a DAC output adjustment but then be measured at above the commanded value afterwards. An upper tolerance may be defined, for example 110%, so that sensor platform 100 may reverse power scaling in the event of overshoot or oscillations. When the measured instantaneous output is greater than the lower threshold and less than the upper threshold, adjustments by DAC 174 may be halted, for example to delay for a settling period, or to exit the coarse adjustment phase. The effective frequency of DAC adjustments is limited by low-pass filter 184, which provides electrical protection against oscillation. The maximum frequency of adjustments of DAC 174 may be limited by software to be below RF frequencies, for example 500 Hz. Thereby, the embedded control system is able to reliably modulate a wide range of output power levels.

While performing output adjustments, and during the regulation stage the firmware may operate in a conditional loop, where parameters are measured in real-time, and control parameters may be adjusted during each loop. For example, the software may function to measure the instantaneous power output, then increment the output value of DAC 174. During the following iteration of the software loop the same parameter may be checked and re-adjusted. The quantity of incremental adjustments may be modified during each loop. For example, the rate of change of the output value of DAC 174 may be decreased as the deviation between measured and commanded values decreases.

Sensor platform 100 may be configured to measure the temperature, for example, the ambient temperature or the local temperature of components of sensor platform 100, and modify calibration parameters based on the temperature measurements. For example, the calibration parameters may be multiplied by a coefficient that is related to the measured temperature in order to compensate functionality of sensor platform 100 based on the environmental conditions. In some embodiments, a series of temperature calibration coefficients may be stored in a table or other data structure for use as the temperate values change.

During the regulation stage of the measurement process, the output values of DAC 174 may remain significantly unchanged, with the circuitry of DAC 174 conducting amperage through light source 172 at a steady-state. The software loop may monitor a timing sub-system along with monitoring the control parameters such as instantaneous output power. While the control systems are maintaining output power within tolerance of the commanded value, the timing sub-system may cause the software loop to activate a sub-routine at a predetermined programmed time. For example, a subroutine may be activated once every 10 milliseconds. The subroutine is configured to measure the instantaneous radiant intensity being received by each photodetector unit 152 or the subroutine may be configured to repeat several successive measurements and compute the average these values at a regular interval. The control circuitry is configured to monitor and control the power output with the maximum possible fidelity provided by the processor frequency of sensor platform 100, while the timer provides precise timing of the data sampling cycles.

During the regulation stage, the effects of thermal runaway are inhibited or negated by the previously described process control loop. For example, the Vf of light source 172 may decrease after a portion of the measurement process due to an increase in temperature potentially resulting in a brightness drift despite the amperage remaining constant. The output control loop regulates radiant power directly by measuring the brightness detected by radiant-intensity sensor 254 and adjusting output power accordingly to remain within tolerance.

As mentioned above, light source 172 may be adjustable between a variety of radiant power output levels as directed by software or an end user. For example, the light source may be configured to emit radiant power at 5 mW, 10 mW, 15 mW, 20 mW, 25 mW, 30 mW, 35 mW, 40 mW or any other radiant power output level. The adjustable radiant power output level of light source 172 enables an end user to maximize the dynamic range of sensor platform 100 for any particular chemical sensor reagent and corresponding analyte. For example, an increase in the excitation power from light source 172 typically results in an increase in the optical response from the chemical sensor reagent or analyte when in the presence of one another. An increased optical response may result in increased signal strength at photodetectors 154. For example, in some embodiments, it may be useful to operate sensor platform 100 with the highest possible excitation short of the burning point or chemical decomposition threshold of the chemical sensor reagent or analyte to ensure the highest quality of signal strength received at photodetectors 154. In one example scenario, the amount of light reflected or emitted from the sample region, e.g., by an excited sample, may be relatively small at a lower radiant power output level such as 5 mW or 10 mW. In such a case, the radiant power output level may be increased, e.g., to 30 mW to increase the light reflected or emitted from the sample region and detected by photodetectors 154. In such an embodiment, the equations used to calculate the concentration of the sample based on the reflected or emitted light from the sample region may be adjusted based on the increased excitation power level.

The adjustable light source 172 may also be utilized to cleanse sensor platform 100 of chemical sensor reagents, analytes or other materials. As an example, UV light at a high power level is known to break down many substances including chemical and biological materials such as those that may be used as chemical sensor reagents, those that are components of analytes or a combination of chemical sensor reagent and analyte. In one example scenario, a chemical sensor reagent that is added to a sample material may be excited by light source 172 at some radiant power output levels, e.g., 5 mW-25 mW, but may begin to break down at higher radiant power levels, e.g., 30 mW. In some embodiments, light source 172 may have a cleanse function that may be activated by the end user to cleanse the imaging plate 118 or sample cartridge 230 by applying the UV light at a radiant power level sufficient to break down the chemical sensor reagent, the analyte or a combination of the chemical sensor reagent and analyte. As an example, a higher radiant power level compared to that used for measurement may be utilized to separate the chemical sensor reagent from the analyte, break down the reagent or the analyte or for any other purpose that may cleanse sensor platform 100 as desired.

Components of sensor platform 100 are configurable for a wide range of use cases. For example, different optical filter elements 160 may be installed in one or more photodetector units 152 of photodetector module 150, specializing each corresponding photodetector 154 for measuring the radiant intensity at a particular wavelength corresponding to an optical characteristic of the chemical sensor reagent and analyte combination as shown, for example, in the charts of FIG. 18. Another element of sensor platform 100 that is configurable is the firmware. The firmware comprises software that is programmed into memory of the computation module of sensor platform 100. Software elements that are programmed into computer networks that are connected to sensor platform 100 may also be configurable. For example, firmware elements may be configured to compute the parts-per-million concentration of the analyte based on raw radiant power measurements from one or more of photodetectors 154 and the measured instantaneous power of light source 172.

Users may interact with a software utility, for example, using a desktop computer or other user device. The software utility may act to generate calibration values, or program calibration values onto sensor platform 100. For example, the software utility may provide an interface, e.g., a graphical user interface for presentation on a display of the user device, by which experimental data is entered into the software, for example by importing CSV files. The software utility may automatically generate calibration values based on the physical components that are installed in sensor platform 100, in combination with characterization data that is entered by the user. In some embodiments, for example, the software utility may be configured to detect the configuration of sensor platform 100, e.g., by receiving configuration data from sensor platform. In some embodiments, the software utility may automatically generate calibration values and provide graphical tools which assist the user in translating the experimental data into calibration values that may enable accurate measurements. For example, the user may interact with the software utility in a conversational format where the user is prompted for key information.

Once chemical sensor reagent characterization data is imported to the software utility, users may be provided crosshairs and graph-tracing utilities, which select numerical data points from a 2D plot, for example, 2D plots generated by the CSV files.

The fully configured and calibrated sensor platform 100 provides a means of deploying the chemical sensor reagents for use outside of the lab. For example, some or all of the components of the configured sensor platform 100 may be contained within a pipe fitting, where a fluid stream is flowing past a window, and the sample region extends into the volume of fluid contained in the pipe. In another example, some or all of the components of the configured sensor platform may be contained within a portable handheld instrument. The handheld instrument may contain additional systems such as a rechargeable battery management system, a GPS receiver, removable memory card reader, a switch keypad, and a graphical user interface. The handheld instrument may be carried in the user's pocket or in a backpack and may be used by scientists or other individuals to perform measurements in remote outdoor environments. For example, the handheld instrument may be used to measure the concentration of a specific analyte in a body of water where the specific analyte to be measured may utilized as a basis for system 10 to configured sensor platform 100 on assembly by selecting an appropriate chemical sensor reagent, photodetector module 150 and light source module 170, and configuring sensor platform 100 in accordance with the optical parameters of that chemical sensor reagent and analyte combination.

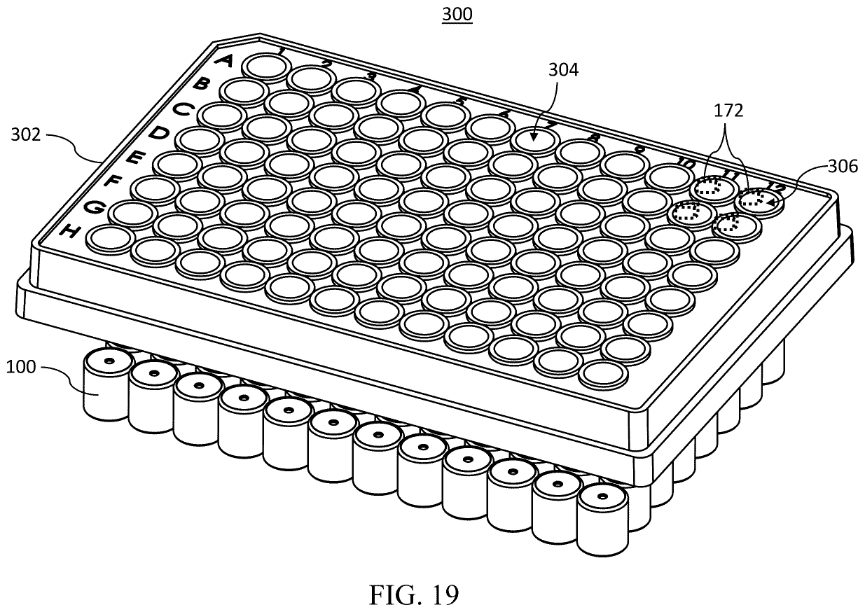

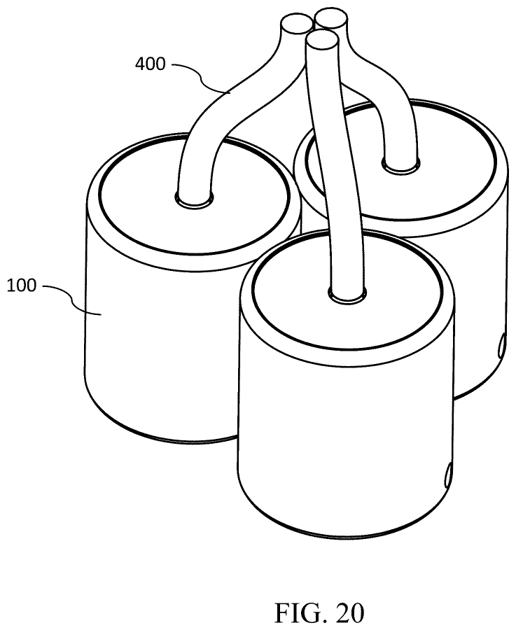

With reference to FIG. 19, components from multiple sensor platforms 100 may be deployed as part of a multi-sample monitoring system 300 that is configured to simultaneously or independently monitor the contents of a plurality of material samples. In an example embodiment, multi-sample monitoring system may comprise a well plate 302 such as, e.g., a 96-well plate, or any other sample containing device. Multi-sample monitoring system 300 may deploy multiple sensor platforms 100, or one or more components of sensor platforms 100, in an array such as, e.g., a planar grid pattern or any other pattern. As shown in FIG. 19, in an embodiment, multi-sample monitoring system 300 may deploy sensor platforms 100 in an eight-by-twelve array configuration for use with a well plate 302 such as, e.g., a 96-well plate or any other well plate. Any other configuration may alternatively be utilized depending on the number and configuration of material sample regions being examined. Well plate 302 comprises sample wells 304 having transparent bottom surfaces that provide a structure for measuring the chemical concentration of several material samples at once. In this embodiment the transparent bottom surfaces of sample wells 304 serve as imaging stages 118 for each corresponding sensor platform 100.

While sensor platforms 100 are shown as being positioned in an array over which well plate 302 is installed for measurement of the sample regions contained in sample wells 304, in other embodiments one or more components may alternatively be disposed on an opposite side of sample wells 304 from other components of sensor platforms 100. As an example, in some embodiments, one or more light sources 172 may be positioned on an opposite side of well plate 302 relative to other components of sensor platforms 100 such as, e.g., photodetectors 154 of photodetectors module 150. This embodiment is shown in FIG. 19 where example light sources 172 are shown in dashed lines. In an embodiment, a light source 172 may be disposed above and on an opposite side of each sample well 304 from the corresponding photodetector 154 of sensor platform 100. In an embodiment, one or more photodetectors 154 may be axially aligned with light source 172 or sample well 304 such that light emitted by light source 172 passes axially through sample well 304 and is received axially by the axially aligned photodetector 154. In some embodiments, sensor platform 100 may comprise a single photodetector 154 with such an axial alignment. In other embodiments, sensor platform 100 may comprise multiple photodetectors 154 such as shown in FIG. 1.

In an embodiment, light source 172 is configured to occlude only a portion of an opening 306 of sample well 308 such that a portion of opening 306 is exposed for receipt of a pipette therethrough into sample well 304 while light source 172 is present. Such a configuration enables real-time or near real-time measurement of chemical processes occurring within sample well 304 throughout the testing process including during dispensation of a chemical sensor reagent, analyte or other material sample into sample well 304.

With reference to FIG. 20, in an embodiment, light guides 400 such as, e.g., fiber optic cables, may be utilized by sensor platforms 100 to optically connect sample wells 304 to sensor platforms 100. For example, in a case where sensor platforms 100 are substantially larger than sample wells 304, it may be difficult or impossible to provide an array of sensor platforms 100 that are aligned with each sample well 304, especially if sample wells 304 are arranged in a tight configuration. The use of light guides 400 enables the array of sensor platforms 100 to optically connect to the transparent bottom surfaces of sample wells 304 such that light may be transmitted to, and received from, sample wells 304 by sensor platforms 100 for measurement.

In systems where several sensor platforms 100, light sources 172, photodetectors 154 or other functional units of sensor platforms 100 are utilized in an array, sensor platforms 100 may share a common data bus. In some embodiments, for example, light sources 172 for multiple sensor platforms 100 may be commonly controlled together or individually by the same set of circuitry via the data bus. In some embodiments, for example, data received from photodetectors 154 may be commonly received together or individually by the same set of circuitry for processing via the data bus. In such a scenario, software parameters of each sensor platform 100, light source 172, photodetector 154 or any other functional units may be communicated to other sensor platforms 100 of the array. Any sensor platform 100 may also be configured to access the light source 172 or photodetector 154 of other sensor platforms 100 connected to the data bus.

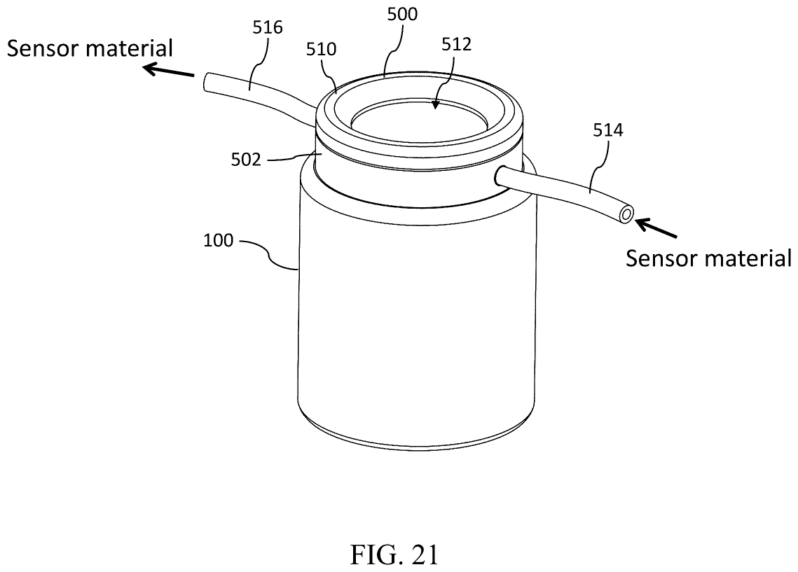

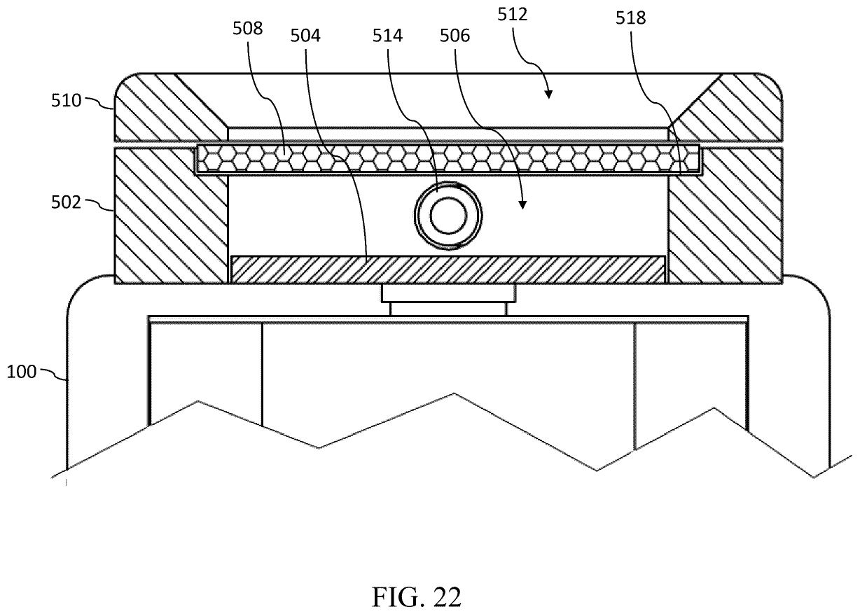

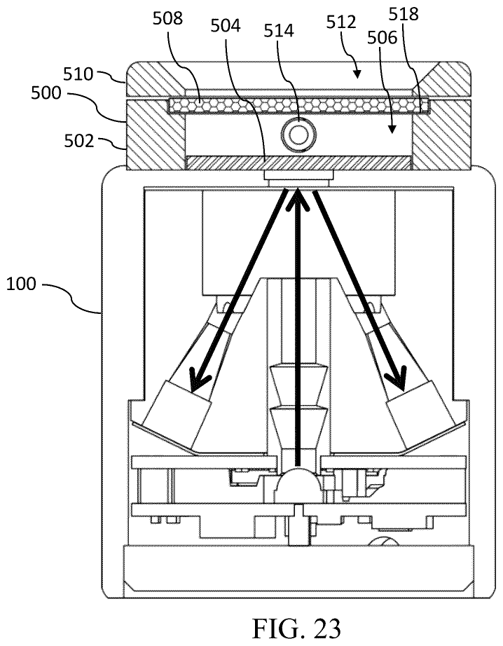

With reference to FIGS. 21-23, a diffusion membrane system 500 may utilized with sensor platform 100 in an embodiment. Diffusion membrane system 500 may be installed on sensor platform 100 or may be integrated into sensor platform 100, e.g., by replacing imaging stage 118.

Diffusion membrane system 500 is configured to isolate ions of the target analyte from the analyte solution and transfer the ions into a solution containing the chemical sensor reagent. Diffusion membrane system 500 comprises a lower housing 502, an imaging stage 504, a sensor cavity 506, a membrane 508, an upper housing 510, a well 512, an inlet 514 and an outlet 516.

Lower housing 502 comprises a lip 518 against which membrane 508 is positioned. The interface between membrane and lip 518 may be sealed or otherwise configured such that intrusion of liquids around membrane 508 via lower housing 502 is inhibited.

Sensor cavity 506 is defined by lower housing 502, imaging stage 504 and membrane 508. Chemical sensor reagent is received within sensor cavity 506 via inlet 514 and flushed out of sensor cavity 506 via outlet 516. In this manner, fresh chemical sensor reagent may be deployed for each measurement or as needed. In this embodiment, sensor cavity 506 comprises the target sample region being measured by sensor platform 100.

Well 512 is defined in upper housing 510. Upper housing 510 is configured for attachment to lower housing 502 such that well 512 is exposed to membrane 508 and may be sealed with lower housing 502 such that liquids are inhibited from exiting from well 512 via the interface between upper housing 510 and lower housing 502, e.g., by an o-ring or in any other manner.

Membrane 508 is configured to inhibit liquid transfer between well 512 and sensor cavity 506 while allowing ion diffusion from well 512 to sensor cavity 506. In some embodiments, a material of membrane 508 may be selective to a transfer of ions of the target analyte from well 512 to sensor cavity 506. In this manner, interferents in the material sample may be inhibited from entry into sensor cavity 506, enabling enhanced measurements of the concentration of the target analyte in the sample by sensor platform 100 while reducing error due to potential interferents.

### Examples

Example 1: A system for rapidly functionalizing chemical sensors from a low technology readiness level to a higher technology readiness level, the system comprising: at least one processor couple to memory, the at least one processor being configured to: obtain data corresponding to optical parameters of the chemical sensor, the data comprising at least one target wavelength for the chemical sensor; select, based on the obtained data, at least one filter corresponding to the target wavelength; select, based on the obtained data, at least one light source that is configured to excite the chemical sensor; assemble, based on the obtained data and the selected at least one filter, a sensor platform comprising: a chassis; a waveguide housing disposed within the chassis, the waveguide housing comprising a filter carrier; a photodetector disposed within the filter carrier; the selected at least one filter disposed within the filter carrier between the photodetector and a sample region of the sensor platform; and the selected light source disposed in optical communication with the sample region.

Example 2: A system comprising: a graphical user interface that is configured for presentation on a display of a user device, the graphical user interface comprising a plurality of elements that are activatable by a user of the user device for controlling a sensor platform including: a first element that is activatable to set a target radiant power output level parameter of a light source of the sensor platform; a second element that is activatable to set a delay period parameter of the sensor platform, the delay period being an amount of time between emission of the radiant power output by the light source toward a sample material and a measurement of an excitation emission of the sample material by at least one photodetector of the sensor platform; and a third element that is activatable to generate an activation command that controls an activation of a measurement process by the sensor platform, the activation command providing the sensor platform with the settings found in first and second elements, the sensor platform being configured to perform the measurement process based on the settings found in the first and second elements.

Example 3: A method comprising: obtaining data corresponding to optical properties of a chemical sensor reagent and analyte combination, the optical properties comprising a measurement wavelength corresponding to the chemical sensor reagent and analyte combination; selecting an optical filter from a plurality of optical filters of a configurable sensor platform assembly based on the obtained data, the optical filter corresponding to a predetermined wavelength that corresponds to the measurement wavelength; and assembling a sensor platform including the selected optical filter, the assembly positioning the selected optical filter within a waveguide of a waveguide housing of the sensor platform between a photodetector of the sensor platform and a sample region of the sensor platform.

Example 4: The method of example 3, wherein: the optical properties comprise a second measurement wavelength corresponding to the chemical sensor reagent and second analyte; the method further comprises selecting a second optical filter from the plurality of optical filters based on the obtained data, the second optical filter corresponding to a second predetermined wavelength that corresponds to the second measurement wavelength; and wherein assembling the sensor platform comprises assembling the sensor platform including the selected second optical filter, the assembly positioning the selected second optical filter within a second waveguide of the waveguide housing of the sensor platform between a second photodetector of the sensor platform and the sample region of the sensor platform.

Example 5: The method of example 4, wherein: the optical properties comprise a third measurement wavelength corresponding to the chemical sensor reagent and third analyte; the method further comprises selecting a third optical filter from the plurality of optical filters based on the obtained data, the third optical filter corresponding to a third predetermined wavelength that corresponds to the third measurement wavelength; and assembling the sensor platform comprises assembling the sensor platform including the selected third optical filter, the assembly positioning the selected third optical filter within a third waveguide of the waveguide housing of the sensor platform between a third photodetector of the sensor platform and the sample region of the sensor platform.

Example 6: A method for controlling a light source of a sensor platform comprising: receiving a power on command comprising a target radiant power output level; executing a bulk increase process, the bulk increase process ramping up a radiant power output of the light source at a first rate; determining that a first threshold radiant power output level has been exceeded by the radiant power output of the light source; executing a fine adjustment process, the fine adjustment process ramping up the radiant power output of the light source at a second rate that is smaller than the first rate; determining that the radiant power output of the light source is equal to or greater than the target radiant power output level; and executing a regulation process, the regulation process maintaining the radiant power output level within a predetermined tolerance of the target radiant power output level.

FIGS. 1 through 23 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A configurable sensor platform assembly comprising:
a universal chassis;
a waveguide housing disposed within the universal chassis, waveguide housing comprising a plurality of waveguides extending therethrough toward a sample region;
a plurality of photodetectors, each photodetector being configured for positioning within a corresponding waveguide of the waveguide housing;
a plurality of optical filters, each optical filter being configured for positioning between a corresponding photodetector of the plurality of photodetectors and the sample region when the corresponding photodetector is positioned in a corresponding waveguide of the waveguide housing, each optical filter corresponding to a predetermined wavelength; and
at least one light source,
wherein the configurable sensor platform assembly is configured to be assembled into a sensor platform, the assembled sensor platform comprising a subset of the plurality of optical filters that are selected for inclusion in the assembled sensor platform based on optical properties corresponding to a target chemical sensor reagent and analyte combination, the optical properties corresponding to a set of measurement wavelengths, the predetermined wavelengths of the selected subset of optical filters corresponding to the set of measurement wavelengths.

2. The configurable sensor platform assembly of claim 1, wherein:
the sensor platform comprises a first sensor platform;
the subset of the plurality of optical filters comprise a first subset of the plurality of optical filters;
the target chemical sensor reagent and analyte combination comprises a first target chemical sensor reagent and analyte combination;
the optical properties corresponding to the first target chemical sensor reagent and analyte combination comprise first optical properties;
the set of measurement wavelengths corresponding to the first optical properties comprise a first set of measurement wavelengths; and
the configurable sensor platform assembly is configured to be assembled into a second sensor platform, the assembled second sensor platform comprising a second subset of the plurality of optical filters that are selected for inclusion in the assembled second sensor platform based on second optical properties corresponding to a second target chemical sensor reagent and analyte combination, the second optical properties corresponding to a second set of measurement wavelengths, at least one measurement wavelength of the second set of measurement wavelengths being different than the measurement wavelengths of the first set of measurement wavelengths, the predetermined wavelengths of the selected second subset of optical filters corresponding to the second set of measurement wavelengths.

3. The configurable sensor platform assembly of claim 1, wherein assembled sensor platform comprises a given light source selected from the at least one light source, the given light source selected for inclusion in the assembled sensor platform based on the optical properties corresponding to the target chemical sensor reagent and analyte combination.

4. The configurable sensor platform assembly of claim 3, wherein the given light source is selected to have an emission wavelength that is configured to cause an optical effect in the target chemical sensor reagent and analyte combination based on the optical properties.

5. The configurable sensor platform assembly of claim 4, wherein the optical effect in the target chemical sensor reagent and analyte combination comprises at least one of an excitation of at least one of the target chemical sensor reagent and analyte and an absorption by at least one of the target chemical sensor reagent and analyte.

6. The configurable sensor platform assembly of claim 1, wherein the configurable sensor platform assembly is configured to be assembled into an array of sensor platforms, the array of sensor platforms being configured to operate simultaneously to measure corresponding sample regions.

7. A configurable sensor platform assembly comprising:
a chassis comprising a sample region;
a waveguide housing configured for positioning within the chassis and comprising a plurality of waveguides; and
a circuit board stack configured for positioning within the chassis adjacent the waveguide housing, the circuit board stack comprising:
a circuit board comprising a light source;
a circuit board comprising a flexible flange; and
a photodetector disposed on the flexible flange, the flexible flange being configured to adjust an angle of a receiving surface of the photodetector relative to the sample region.

8. The configurable sensor platform assembly of claim 7, wherein:
the plurality of waveguides are offset at an angle relative to a coaxial axis of the chassis; and
the flexible flange is configured to adjust the angle of the receiving surface of the photodetector to match the offset of a corresponding waveguide.

9. The configurable sensor platform assembly of claim 8, wherein the flexible flange is adjustable to insert the photodetector at least partially into the corresponding waveguide.

10. The configurable sensor platform assembly of claim 7, wherein the sample region corresponds to a planar imaging plate disposed at an end of the chassis.

11. The configurable sensor platform assembly of claim 7, wherein the sample region corresponds to a sample cartridge inserted at least partially into the chassis.

12. A sensor platform comprising:
a chassis comprising a sample region;
a waveguide housing configured for positioning within the chassis and comprising a plurality of waveguide channels and a light source channel;
a photodetector module comprising a plurality of photodetectors, each photodetector being configured for insertion at least partially into a corresponding waveguide channel of the plurality of waveguide channels; and
a light source module comprising a light source, the light source being configured to emit light toward the sample region through the light source channel of the waveguide housing.

13. The sensor platform of claim 12, wherein:
each waveguide channel comprises a stop element; and
an amount of the insertion of each photodetector is inhibited by the corresponding stop element.

14. The sensor platform of claim 13, wherein:
the photodetector module further comprises an optical filter element, the optical filter element being disposed on a given photodetector of the plurality of photodetectors between the given photodetector and the sample region; and
the amount of the insertion of the given photodetector is inhibited by an engagement of the optical filter element against the corresponding stop element.

15. The sensor platform of claim 12, wherein:
the plurality of waveguide channels and the light source channel are each oriented toward the sample region;
the light source channel extends axially through the waveguide housing toward the sample region; and
each waveguide channel extends away from the sample region at an oblique angle to the light source channel.

16. The sensor platform of claim 12, wherein the light source channel comprises an optical pathway, the optical pathway comprising internal surfaces that are configured to inhibit reflections of light emitted by the light source.

17. The sensor platform of claim 16, wherein the internal surfaces of the optical pathway comprise at least one of a ridged baffle and a light absorbent material.

18. The sensor platform of claim 12, wherein the light source module further comprises a radiant-intensity sensor that is configured to measure a radiant power of the light source, the sensor platform being configured to control an output of the light source based at least in part on the measured radiant power.

19. The sensor platform of claim 18, wherein the radiant-intensity sensor is optically isolated from the sample region.

20. The sensor platform of claim 12, further comprising a diffusion membrane system, the diffusion membrane system comprising:
a lower housing configured for attachment to the chassis;
an upper housing attachable to the lower housing;
a membrane disposed between the upper housing and the lower housing;
a sensor cavity disposed between the chassis, the lower housing and the membrane, the sensor cavity being configured to receive a chemical sensor reagent therein, the sensor cavity comprising the sample region; and
a well disposed between the membrane and the upper housing, the well being configured to receive a solution containing a target analyte therein, the membrane being selective to the target analyte and configured to transfer ions of the target analyte from the well to the sensor cavity.
